(19) United States
(12) Patent Application Publication
(10) Pub. No.: US 2011/0247913 A1
(43) Pub. Date: Oct. 13, 2011

(54) Method of buffering and accumulating objects, such as plastic containers, between sequential or industrial processes

(76) Inventor: David Kirk Ogden, Pocahontas, IL (US)

(21) Appl. No.: 12/804,731

(22) Filed: Jul. 29, 2010

Related U.S. Application Data
(60) Provisional application No. 61/342,135, filed on Apr. 9, 2010.

(51) Int. Cl. B65G 37/00; B65G 47/52

(52) U.S. Cl. 198/347.1

(57) ABSTRACT

A simple and reliable passive method of temporarily accumulating or buffering objects upon a rotating table at an intermediate point typically between two industrial processes. Wheels are suspended from above the rotating accumulation table surface on a vertical axis causing the accumulated objects to be incrementally deflected toward either the table center or toward the table perimeter. Objects deflected toward the table center accumulate on the rotating table surface. Objects deflected to the perimeter eventually engage a chute where they exit toward the next downstream operation.

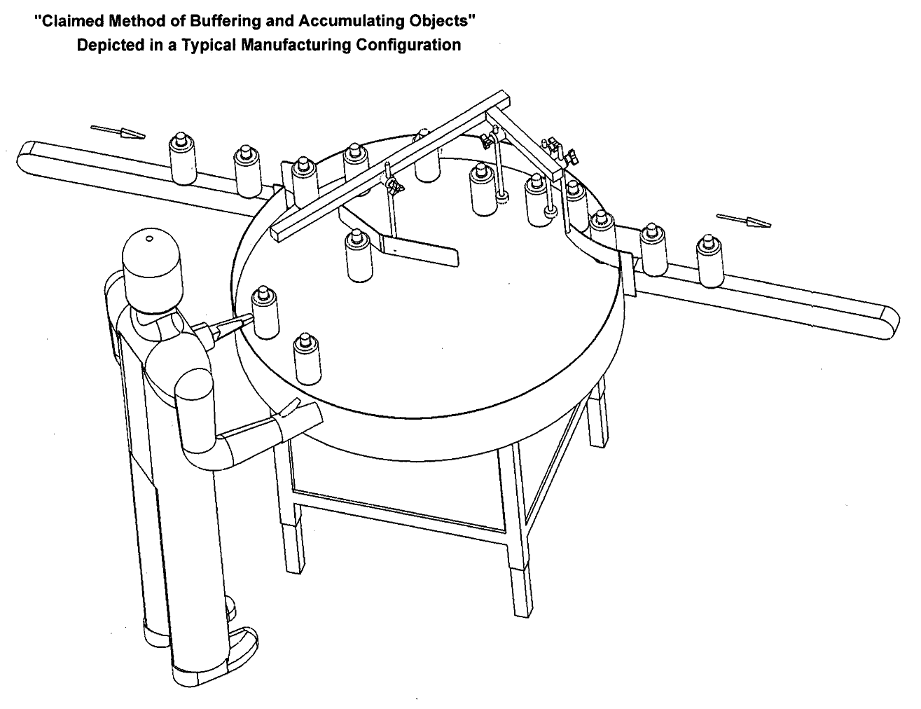

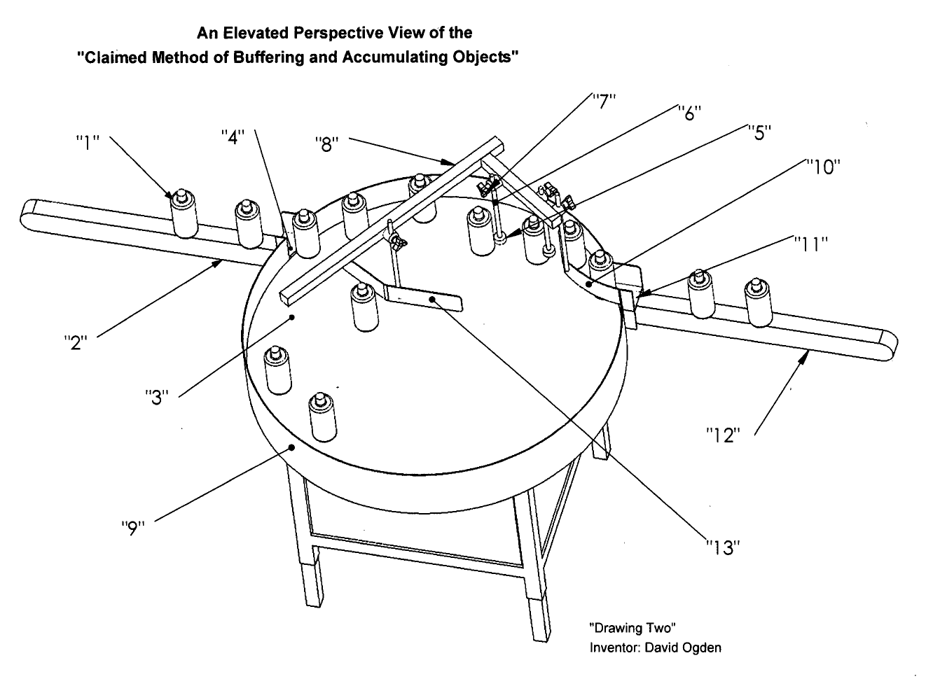

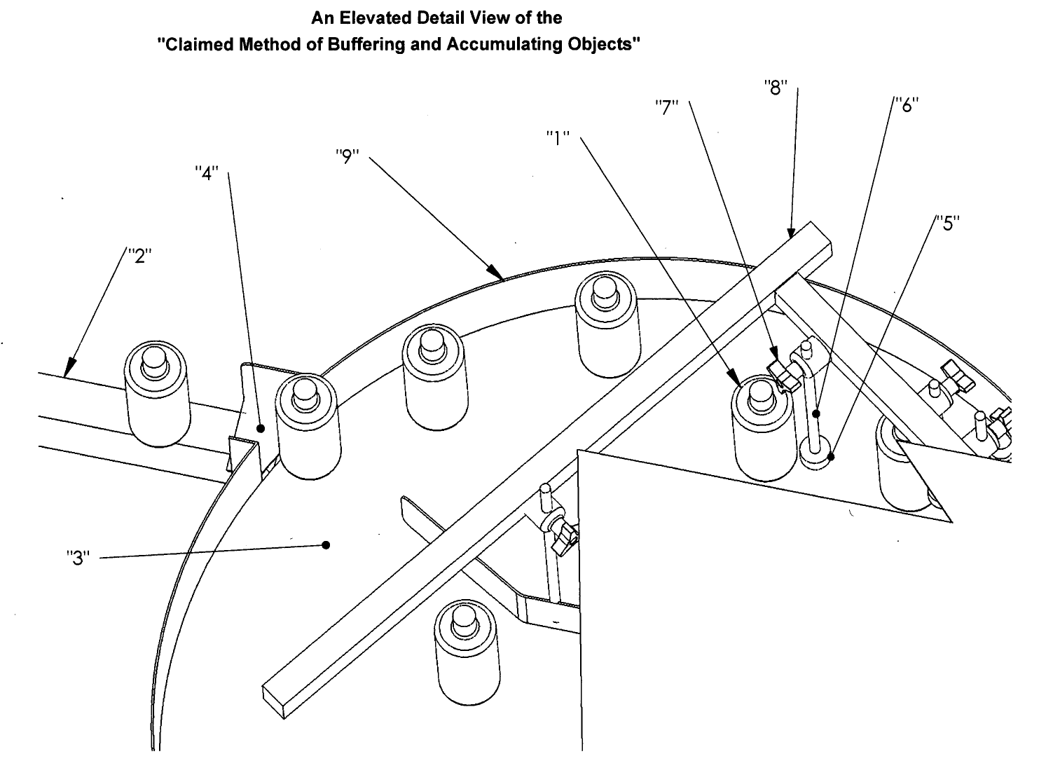

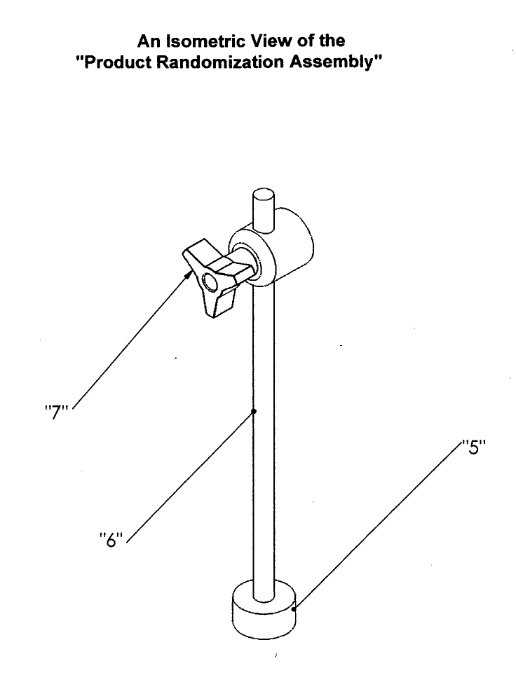

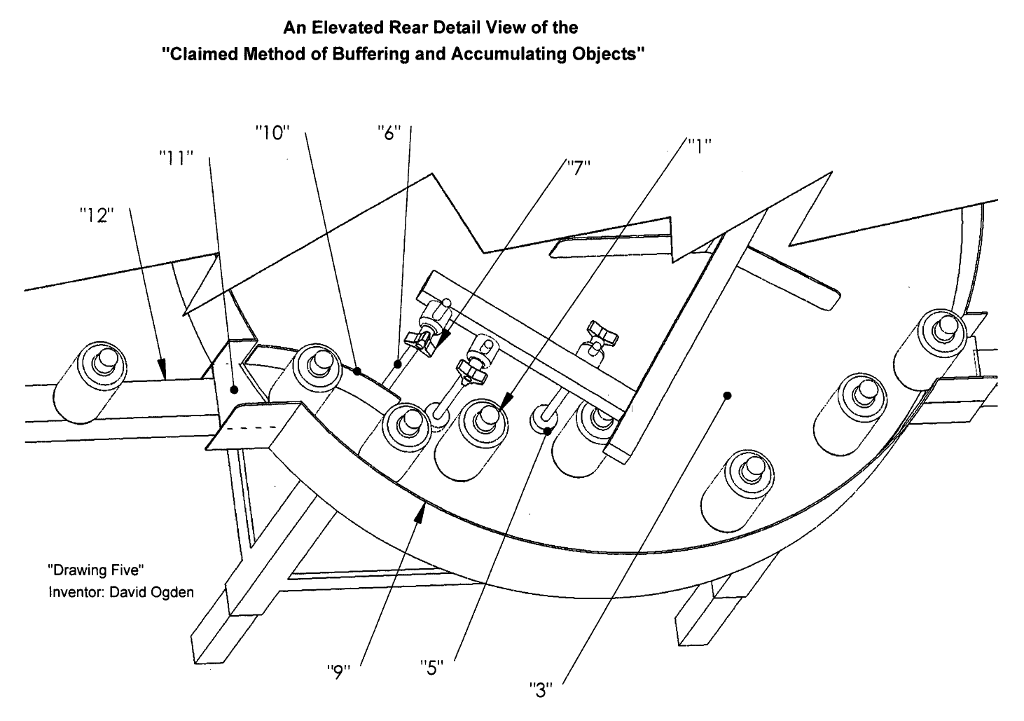

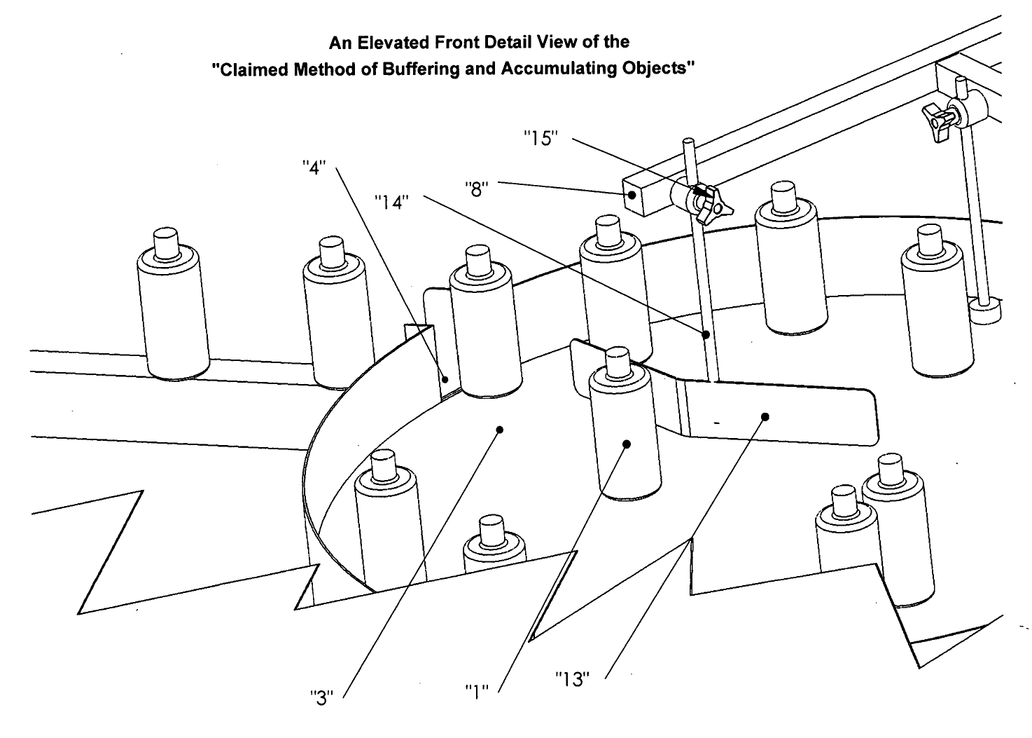

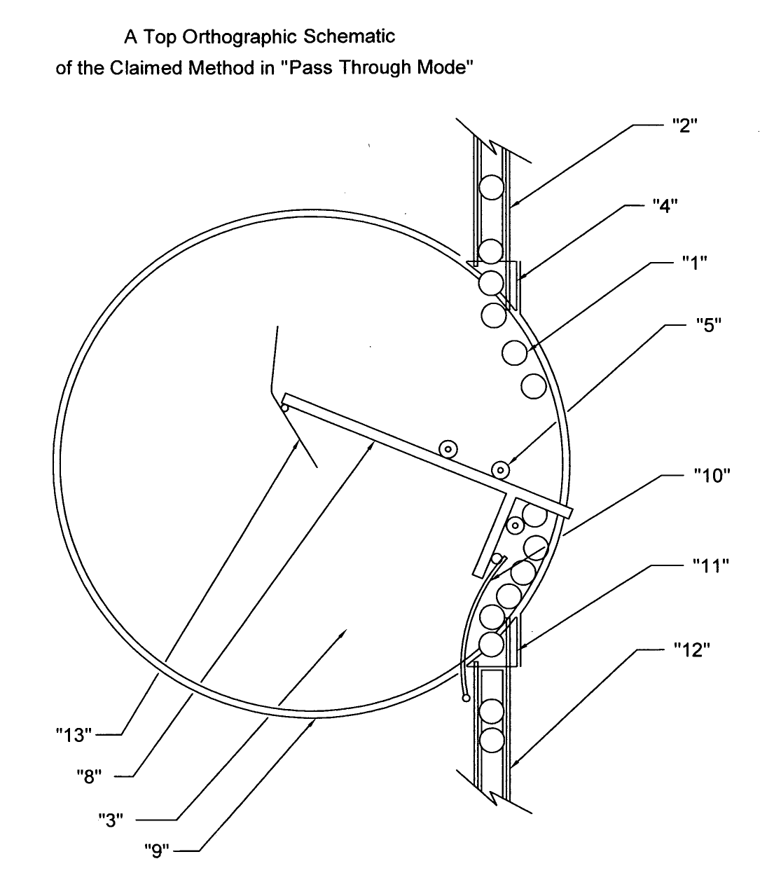

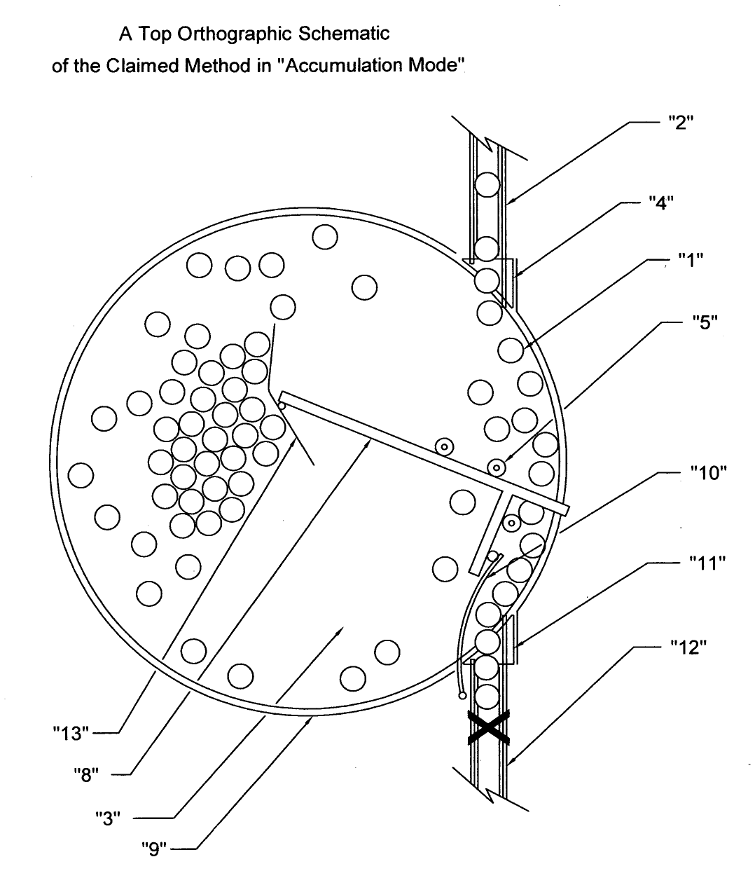

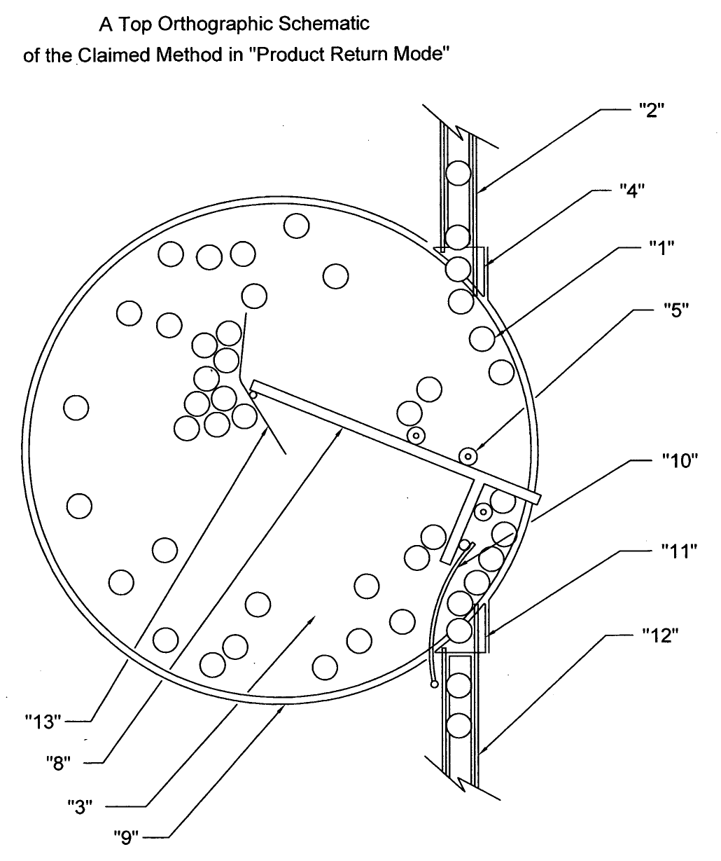

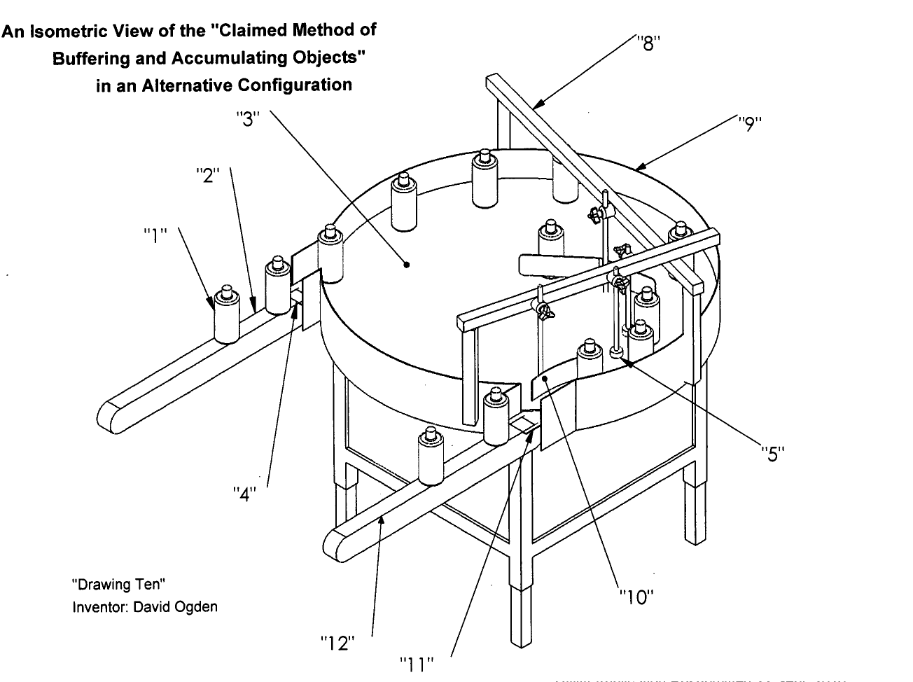

### BACKGROUND

In the manufacture of many products, various industrial operations must be performed in a sequence. Often the product is moved from one process to another upon a conveyor. It is inevitable that certain manufacturing operations become interrupted for short periods of time. During these interruptions, it is desirable that the upstream manufacturing operation(s) remain uninterrupted and functioning so as to maximize the overall productivity of the production process. During periods when downstream operations are interrupted, achieving efficient accumulation of in-process product becomes problematic.

Various methods have been developed as to accumulate in-process objects in a manufacturing environment, such as long lengths of conveyor. The inventor suggests that current practices are either more expensive, more complex, or occupy more floor space that his claimed method for accumulating objects at an intermediate point in the manufacturing process.

For example, in the manufacture of plastic containers, bottles are produced in a molding machine, then travel in an upright configuration through various inspection, surface treatment, packaging, and other operations. If, for example, an automatic packaging system runs out of boxes, bottles immediately begin to accumulate upstream the automatic packaging system. The system operator is frustrated by the need to simultaneously reload boxes into the packaging system and deal with the back-up of bottles. Faced with this dilemma, the product is often diverted to scrap or into bulk boxes which are inconvenient to rework onto the production line and/or are vulnerable to product contamination.

### DESCRIPTION OF DRAWINGS

‘Drawing One’—“An Elevated Perspective View of the Claimed Method in a Typical Manufacturing Environment”. This drawing depicts the claimed buffering system in a typical manufacturing environment, including a representation of a human model to provide proportional context.

‘Drawing Two’—“An Elevated Perspective View of the Claimed Method of Buffering and Accumulating Objects”. This drawing depicts the majority of components needed to achieve the claimed method of accumulating products being produced or originating from an upstream process and subsequently dispatch these products to a downstream process.

‘Drawing Three’—“An Elevated Detail View of the Claimed Method of Buffering and Accumulating Objects”. This drawing details components which guide products as they enter the accumulation table surface and randomize or reposition the location of these products.

‘Drawing Four’—“An Isometric View of the Claimed Product Randomization Wheel”. This isometric drawing depicts the (three) component assembly which form a ‘product randomization wheel’, an integral element of the claimed buffering system.

‘Drawing Five’—“An Elevated Rear Detail View of the Claimed Method of Buffering and Accumulating Objects”. This drawing details components which guide products as they exit from the accumulation table surface.

‘Drawing Six’—“An Elevated Front Detail View of the Claimed Method of Buffering and Accumulating Objects”. This drawing details components which guide accumulated products returning to the downstream process.

‘Drawing Seven’—A Top Orthographic Schematic of the Claimed Method in “Pass Through Mode”. In this drawing, containers or similar objects are depicted as they enter the claimed buffer system and continue to a downstream process.

‘Drawing Eight’—A Top Orthographic Schematic of the Claimed Method in “Accumulation Mode”. In this drawing, a blockage or interruption has occurred to the downstream process. Containers or similar objects are depicted as they enter the buffer system and accumulate on the rotating table surface.

‘Drawing Nine’—A Top Orthographic Schematic of the Claimed Method in “Return Mode”. In this drawing, the blockage or interruption depicted in ‘Drawing Eight’ to a downstream process has been removed or corrected, allowing containers to resume movement towards the downstream process.

‘Drawing Ten’—“An Elevated Perspective View of the Claimed Method of Buffering and Accumulating Objects in an Alternative Configuration”. This drawing depicts an alternative arrangement of the claimed invention's components to accommodate various conveyor configurations.

### EXPLANATION OF DRAWINGS

Item 1—A typical “product” such as a plastic container. (Not part of claim, but referenced to provide context for the invention)

Item 2—An “entry conveyor”, a typical, commercially available tabletop conveyor as commonly used to transport products between industrial manufacturing processes. In this application, the “entry conveyor” is supplying in-process “product” from an upstream process or industrial operation. (The “entry conveyor” is not part of claim, but referenced to provide context for the invention)

Item 3—A “rotating accumulation table”, typically constructed from a sheet of polished stainless steel, a flat plastic sheet, or a laminate material upon which “product” (Item 1) is accumulated or buffered. The methodology by which rotation is imparted to the table is not prescribed by this claim.

Item 4—An “entry shed plate”, typically formed from a sheet of polished stainless steel or an engineering grade polymer, which supports and provides a means of transitioning the product (Item 1) from a tabletop conveyor or “entry conveyor” (Item 2) onto the surface of a “rotating accumulation table” (Item 3).

Item 5—A “randomization wheel” which by direct contact imparts randomization or alters the relative position of the “product” (Item 1). The “product randomization” wheel (Item 5) could be as simple as a commercially available ball bearing assembly with a polished outer race surface and rotates freely in clockwise or counter-clockwise directions.

Item 6—A “vertical axle”, typically a length of commercially available shafting positioned in a vertical orientation and onto which the “randomization wheel” (Item 5) is pressed or mounted.

Item 7—A commercially available “swivel cap assembly” through which a rod such as the “vertical axle” (Item 6) is inserted and retained. Effective randomization of the “product” (Item 1) is achieved by locating the various “randomization wheels” (Item 5) at vertical elevations just above the surface of the “rotating accumulation table” (Item 3). Randomization and/or other positional manipulation of the “product” (Item 1) is achieved by locating the “randomization wheels” (Item 5) and “vertical axles” (Item 6) at radial locations inward from the “perimeter fence” (Item 9) at locations which may be equal to multiples of the radius of the “product” (Item 1).

Item 8—An “overhead support” provides mechanical support of the product randomization assemblies (items 5, 6, and 7) and plow assembly (items 13, 14, and 15).

The “overhead support” (Item 8) may also provide mechanical support of the “exit chute” (Item 10). The “overhead support” may be constructed from any material or mounted in any configuration so long as it does not interfere with the free movement of the “product” (Item 1).

Item 9—A “perimeter fence”, typically formed from a sheet of polished stainless steel, is stationary and mounted outside the perimeter of the “rotating table surface” (Item 3). Openings in the stationary “perimeter fence” are provided at points adjacent to the “entry shed plate” (Item 4) and “exit shed plate” (Item 11).

Item 10—An “exit chute”, formed from polished sheet metal, plastic, or similar material which is flexible or is formed in such a shape as to provide guidance and support of “products” (Item 1), as they exit from the surface of the “rotating accumulation table” (Item 3).

Item 11—An “exit shed plate”, typically formed from a sheet of polished stainless steel or engineering grade polymer, which supports and provides a means of transitioning the “product” (Item 1) from “rotating accumulation table” (Item 3) onto the “exit conveyor” (Item 12).

Item 12—An “exit conveyor”, a typical, commercially available tabletop conveyor as used commonly to transport products between industrial manufacturing processes. In this application, the “exit conveyor” is transporting in-process “product” (Item 1) toward a downstream process or industrial operation. (The “exit conveyor” is not part of claim, but referenced to provide context for the invention.)

Item 13—A “plow” or fence which sweeps the central portion of the “rotating accumulation table” (Item 3). The “plow” would be typically formed from a narrow length of stainless steel sheet metal or similar material.

Item 14—A “plow support rod” consisting of a length of commercially available shafting is positioned in a vertical axis and is mechanically connected to the “plow” (Item 13).

Item 15—A commercially available “swivel cap assembly” through which the “plow support rod” (Item 14) is inserted and retained. The location and angle of the “plow” (Item 13) is thus adjusted to a location upon the “overhead support” (Item 8) as required to impart movement of accumulated “product” (Item 1) away from the center surface of the “rotating accumulation table” (Item 3) and toward the “perimeter fence” (Item 9).

001) Sequential Industrial Operations—It is a common and accepted practice in the manufacture of many products for said products be transported by a conveyor or series of conveyors through a series of sequential operations or processes. An example of a sequential manufacturing process would be in the manufacture or filling of plastic bottles where the containers are transferred by a tabletop or similar conveyor through a series of molding, inspection, decorating, filling, and/or packaging operations.

002) Advantage of Production Buffers—It is frequently desirable that a means of accumulating or buffering in-process goods or products be provided at strategic points along a manufacturing transfer line so that production throughput is optimized despite short term interruptions to individual processes.

003) General Context of the Invention—While a large number of devices and contrivances have been developed for accumulating products in a manufacturing environment, the Inventor claims an improved method of accumulation and buffering in many industrial applications when a stream of products, such as upright plastic bottles, transfer between processes upon a conveyor. ‘Drawing One’ depicts the claimed method as it would typically be integrated between an upstream function, such as a molding operation, and a downstream function, such as an automatic case packer in a plastic bottle manufacturing facility.

004) Overview of Product Movement and Accumulation—‘Drawing Two’ provides an elevated perspective view as the flow of “products” (Item 1) originating from an upstream process are traveling upon a typical tabletop conveyor or “entry conveyor” (Item 2). This flow is depicted in ‘Drawing Two’ in a left to right direction. Said “products” (Item 1) are accumulated and/or transported upon the “rotating accumulation table” (Item 3) in a manner described in paragraphs ‘005’ through ‘022’. The “product” (Item 1) subsequently travels to the right as depicted in ‘Drawing Two’ toward a downstream process upon an “exit conveyor” (Item 12).

005) Product Transfer to Accumulation Surface—‘Drawing Two’ and ‘Drawing Three’, depict overhead views of the claimed Invention in which plastic bottles or similar “products” (Item 1) are directed to an “entry shed plate” (Item 4) at an opening in the “perimeter fence” (Item 9). The back pressure of upstream containers or “product” (Item 1) upon the tabletop conveyor or “entry conveyor” (Item 2) pushes adjoining “product” (Item 1) residing onto the “entry shed plate” (Item 4) in a forward vector. This forward thrust causes the base of the “product” (Item 1) to contact the surface of the “rotating accumulation table” (Item 3). The “rotating accumulation table” (Item 3) is in continuous rotation and thus imparts a curvilinear thrust on the base of the “product” (Item 1). The “product” is thus transported away from the “entry shed plate” (Item 4) and allows additional “product” (Item 1) to move forward in succession.

006) Description of the Product Randomization Assembly—‘Drawing Four’ depicts a claimed “product randomization assembly” consisting of a “swivel cap assembly” (Item 7), a “vertical shaft” (Item 6), and a “randomization wheel” (Item 5). An “overhead support” (Item 8) is suspended over the “rotating accumulation table” (Item 3). Upon this “overhead support” (Item 8) are mounted a number of said “product randomization assemblies”. Each “product randomization assembly” is a configured so that the “swivel cap assembly” (Item 7) is bolted or similarly mechanically attached to the “overhead support” (Item 8). A “vertical axle” (Item 6) is inserted in a vertical downward orientation through the “swivel cap assembly” (Item 7). Each “vertical axle” (Item 6) serves as an axle for the mounting of a “randomization wheel” (Item 5). The “overhead support” (Item 8) is configured in such a manner that it and the “product randomization assemblies” (Items 5, 6, and 7) attached thereto do not interfere with the free movement of “product” (Item 1) upon the “rotating accumulation table” (Item 3).

007) Interaction between Randomization Wheels and the Product—As each “product” (Item 1) is carried upon the “rotating accumulation table” (Item 3), the “product” eventually encounters one or more “randomization wheels” (Item 5) as described in ‘paragraph 006’. Depending on the relative location of any individual “product” (Item 1) with relation to the centerline of any particular “randomization wheel” (Item 5), the “product” is deflected outward towards the “perimeter fence” (Item 9), or deflected inward toward the center of the “rotating accumulation table” (Item 3). Over a period of time, this interaction between the “randomization wheel” (Item 5) and the “product” (Item 1) causes the relative location of the “product” (Item 1) to become altered or randomized upon the surface of the “rotating accumulation table” (Item 3)

007, continued) and thus achieves the Inventor's “Claim I” to “Provide a reliable, passive method of randomizing or altering the location of products or objects upon a conveyor or accumulation surface so that, through repeated interaction with the randomization device(s), the objects naturally migrate toward the area of the conveyor or accumulation surface which is most vacant or unobstructed.”

008) Product Bridging and Blockage Prevented—Occasionally, “product” (Item 1) may randomly contact the perimeter of an “randomization wheel” (Item 5) as described in ‘paragraph 007’ at the exact centerline of said “randomization wheel”. The low coefficient of friction of the polished outer perimeter of the “randomization wheel” (Item 5) and/or the rotation of same assure that “product” (Item 1) cannot remain in a location which would cause the “product” to become interlocked and/or blocked.

009) Description of Exit Chute—‘Drawing Two’ provides an elevated view in which the “exit chute” (Item 10) is positioned downstream from the location of the “entry shed plate” (Item 4) with reference to the clockwise direction of rotation of the “rotating accumulation table” (Item 3). The “exit chute” (Item 10) is mounted adjacent and parallel to the “perimeter fence” (Item 9) so as to form an opening of sufficient width to allow entry of “product” (Item 1).

010) Outward Migration of Product—When the surface of the “rotating accumulation table” (Item 3) is relatively vacant, the process of randomization as described in ‘paragraph 007’ causes the majority of the plastic bottles or similar “products” (Item 1) to migrate toward the “perimeter fence” (Item 9).

011) Movement of Product to the Exit Chute—‘Drawing Five’ provides an elevated rear detail view of the claimed system in which “product” (Item 1) has migrated towards the “perimeter fence” (Item 9) as described in ‘paragraph 010’ and subsequently enters the “exit chute” (Item 10) as described in ‘paragraph 009’.

012) Movement of Product to the Exit Shed Plate—The back pressure imparted on the bases of the “product” (Item 1) while constrained within the “exit chute” (Item 10) by the moving surface of the “rotating accumulation table” (Item 3) cause the “product” (Item 1) to be driven onto the “exit shed plate” (Item 11).

013) Description of the Exit Shed Plate—‘Drawing Five’ provides an elevated rear detail view of an “exit shed plate” (Item 11) mounted at the terminus of the “exit chute” (Item 10). The upper surface of the “exit shed plate” (Item 11), “rotating accumulation table” (Item 3), and the top surface of the downstream or “exit conveyor” (Item 12) are all located on the same plane. An opening in the “perimeter fence” (Item 9) is provided adjacent to the “exit shed plate” (Item 11) to allow a point of egress for the “product” (Item 1).

014) Process by which Product Exits the Accumulation Table—The back pressure imparted by upstream “product” (Item 1) remaining on the “rotating accumulation table” (Item 3) as described in ‘paragraph 012’ continues to push the bottles or “product” (Item 1) residing on the “exit shed plate” (Item 11) forward in succession until the “product” contacts the surface of the “exit conveyor” (Item 12). The movement of the “exit conveyor” (Item 12) is imparted onto the bases of the “products” (Item 1), causing them to move away from the “exit shed plate” (Item 11) and allows more “products” to move forward and towards a downstream process or subsequent industrial operation.

015) Description of ‘Pass Through Mode’—‘Drawing Seven’ provides an orthographic schematic of the claimed system in “pass through mode” where a typical downstream industrial operation, such as an automatic case packer, is functioning normally. Interaction of the “randomization wheels” (Item 5) and the bottles or “products” (Item 1) as described in ‘paragraph 007’ and ‘paragraph 010’ causes the majority of “products” to migrate toward the outer portion of the “rotating accumulation table” (Item 3). “Product” (Item 1) moves freely through the “exit chute” (Item 10) and onto the “exit conveyor” (Item 12) as described in “paragraph 012” and “paragraph 014”.

016) Description of ‘Accumulation Mode’—‘Drawing Eight’ provides an orthographic schematic of the claimed system in “accumulation mode” where the downstream operation is temporarily interrupted, causing “product” (Item 1) to stop, backlog, and/or accumulate upon the “exit conveyor” (Item 12). This blockage will cause the transfer of “product” (Item 1) to the “exit chute” (Item 10) as described in ‘paragraph 012’ to be interrupted.

017) Product Accumulation during a Downstream Interruption—In the event of an interruption to the downstream process as described in ‘paragraph 016’, “product” (Item 1) may continue to enter the “rotating accumulation table” (Item 3) as described in ‘paragraph 005’.

“Product” (Item 1) which continues to entering the claimed system during an interruption to downstream operations interacts with the randomization wheels (Item 5) in a manner described in ‘paragraph 007’ and migrates towards the center surface of the “rotating accumulation table” (Item 3).

018) Achievement of Inventor's Claim II—The claimed system provides accumulation during periods of downstream blockage as described in ‘paragraph 016’ and ‘paragraph 017’ without adversely effecting or interrupting the upstream process or the flow of product on the “entry conveyor” (Item 2). The Inventor's “Claim II”, to “Provide a simple, passive means of automatically storing or buffering objects at an intermediate point of a manufacturing or similar sequential process without the need for sensors, actuators or other complex automation components” is thus achieved.

019) Description of ‘Product Return Mode’—‘Drawing Nine’ provides an orthographic schematic of the claimed system in “product return mode” where the blockage or interruption to the downstream process as described in ‘paragraph 016’ and ‘paragraph 017’ is relieved the downstream operation returns to normal operation. Movement of “product” (Item 1) in the area of the “exit chute” (Item 10) resumes after an interruption, causing open space to become available again behave in the manner described in “paragraph 010”.

019, continued) Randomization of the “product” (Item 1) as imparted by the “randomization wheels” (Item 5) and described in ‘paragraph 007’ is resumed, causing the “product” (Item 1) previously accumulated during the interruption period as described in “paragraph 017” upon the “rotating accumulation table” (Item 3) to migrate towards the “perimeter fence” (Item 9) and subsequently the “exit chute” (Item 10).

020) Description of the Plow—‘Drawing Six’ provides an elevated front detail view in which a “plow” (Item 13) is supported by a “plow support rod” (Item 14). The vertical position and radial location of the “plow” (Item 13) and “plow support rod” (Item 14) are controlled by the “swivel cap assembly” (Item 15) and its attachment to the “overhead support” (Item 8).

021) Product Density and Relative Location upon Accumulation Surface—As the period of interruption as described in ‘paragraph 016’ and ‘paragraph 017’ increases, the number of objects or “product” (Item 1) residing upon the “rotating accumulation table” (Item 3) may be expected to increase. These additional “products” (Item 1) will have accumulated towards the center of the “rotating accumulation table” (Item 3) as the space adjoining the “perimeter fence” (Item 9) becomes more densely populated with “product” (Item 1).

022) Function of the Plow—After a large population of “product” (Item 1) has accumulated during an extended downstream interruption, the center of the “rotating accumulation table” (Item 3) will become filled as described in ‘paragraph 021’. Successfully returning these “products” (Item 1) residing in the center portion of the “rotating accumulation table” (Item 3) may be achieved with a “plow” (Item 13) as described in ‘paragraph 020’. The “plow” (Item 13) is oriented in such a manner so that is surface is tangent to the rotational direction of the “rotating accumulation table” (Item 3). Motion is imparted from the “rotating table surface” (Item 3) to the bases of the accumulated “product” (Item 1) and thus causes the “product” to migrate towards various randomization wheels (Item 5) and the “perimeter fence” (Item 9) and unload in the manner described in ‘paragraph 010’. Alternatively, the “plow” may be substituted with an additional number of randomization wheels (Item 5) in the manner described in ‘paragraph 006’.

023) Achievement of Inventor's Claim III—The claimed system's ability to return product to a downstream operation upon its return to normal operation in an upright and oriented condition as described in ‘paragraph 010’, ‘paragraph 019’, and ‘paragraph 022’ thus fulfills the Inventor's “Claim III” to “provide an inexpensive, effective, and organized means of assuring in process products or objects are consistently returned to a manufacturing operation or similar sequential process after an interruption to that operation or process and without the need of human intervention”.

024) Alternative Configurations for Product Entry—‘Drawing Ten’ provides an elevated perspective view of the claimed system with an alternative entry location of “product” (Item 1) via the claimed “entry shed plate” (Item 4) and opening in the “perimeter fence” (Item 9). In the configuration depicted in ‘Drawing Ten’, the “entry conveyor” (Item 2) and “exit conveyor” (Item 12) are operating in opposite directions. Alternative entry locations may be desirable due to space constraints, conveyor layouts, the location of other production machinery, and/or other obstacles in the manufacturing environment.

025) Alternative Configurations for Product Exit—‘Drawing Ten’ provides an elevated perspective view of the claimed system with an alternative exit location for “product” (Item 1) via the claimed “exit shed plate” (Item 11) and opening in the “perimeter fence” (Item 9). In the configuration depicted in ‘Drawing Ten’, the “entry conveyor” (Item 2) and “exit conveyor” (Item 12) are operating in opposite directions. Alternative exit locations may be desirable due to space constraints, conveyor layouts, the location of other production machinery, and/or other obstacles in the manufacturing environment.

### SUMMARY OF CLAIMS

The Inventor claims his ‘Method of Buffering and Accumulating Objects, such as Plastic Containers, Between Sequential or Industrial Processes’ provides the following benefits which are not available in existing designs.

I. Provide a reliable, passive method of randomizing or altering the location of products or objects upon a conveyor or accumulation surface so that, through repeated interaction with the claimed randomization device(s), the objects naturally migrate toward the area of the conveyor or accumulation surface which is most vacant or unobstructed.

II. Provide a simple, passive means of automatically storing or buffering objects at an intermediate point of a manufacturing or similar sequential process without the need for sensors, actuators or other complex automation components.

III. Provide an inexpensive, effective, and organized means of assuring in-process products or objects are consistently returned to a manufacturing operation or similar sequential process after an interruption to that operation or process and without the need of human intervention.
